(19) United States
(12) Patent Application Publication
(10) Pub. No.: US 2025/0322767 A1
(43) Pub. Date: Oct. 16, 2025

(54) INTERACTIVE VOCABULARY CARD GAME

(71) Applicant: Chanel Von Brown, Milwaukee, WI (US)

(72) Inventor: Chanel Von Brown, Milwaukee, WI (US)

(21) Appl. No.: 18/631,487

(22) Filed: Apr. 10, 2024

(51) Int. Cl. G09B 19/22

(52) U.S. Cl. CPC G09B 19/22

(57) ABSTRACT

The card game has a plurality of vocabulary cards and a receptacle to hold the plurality of vocabulary cards in a randomized pattern. The plurality of vocabulary cards are of two equal collections of cards, definition cards and word cards. The definition cards are half of the total cards, and have a design element, a definition and a QR code. The word cards are half of the total cards, and have a design element, a vocabulary word, a sentence using the vocabulary word, and a QR code. Each definition card has a matching word card and the matching set of 10 cards have the same design element. The reverse sides of both collections of cards are either blank or have a logo.

### SUMMARY

Disclosed herein is an interactive vocabulary card game and a method of playing an interactive vocabulary card game.

In some embodiments, the card game comprises a plurality of vocabulary cards and a receptacle to hold the plurality of vocabulary cards in a randomized pattern. The plurality of vocabulary cards include two equal collections of two different types of cards, definition cards and word cards. The first collection of vocabulary cards are definition cards, comprising half of the total cards. Each definition card has on the first major surface a design element, the definition of a vocabulary word and a QR code that links to a vocabulary application with vocabulary words and definitions. The second major surface of each definition card is either blank or contains a name, logo or combination thereof for the game. The second collection of vocabulary cards are word cards, comprising half of the total cards. Each word card has on the first major surface a design element, a vocabulary word, a sentence using the vocabulary word, and a QR code that links to a vocabulary application with vocabulary words and definitions. The second major surface of each word card is either blank or contains a name, logo or combination thereof for the game. Each definition card has a matching word card to form a matching set of cards, and the matching set of cards have the same design element.

Also disclosed are methods for playing the game. In some embodiments, the game is played by at least three players, with each player in turn becoming an asker, to ask of one or more of the other players (the asked) if one of his or her cards matches with a card of the asked. Depending upon the response of the asked, and the actions of the asker, the asker and/or asked may gain or lose points.

### BRIEF DESCRIPTION OF THE DRAWINGS

The present application may be more completely understood in consideration of the following detailed description of various embodiments of the disclosure in connection with the accompanying drawings.

FIG. 1A is a top view of the first major surface of a vocabulary card of the second collection of cards (word cards).

FIG. 1B is a top view of the second major surface of a vocabulary card of the second collection of cards (word cards).

FIG. 2A is a top view of the first major surface of a vocabulary card of the first collection of cards (definition cards).

FIG. 2B is a top view of the second major surface of a vocabulary card of the first collection of cards (definition cards).

### DETAILED DESCRIPTION

According to the website WISEVOTER, the USA's 2023 literacy rate ranked number 51 in the world, and yet the USA ranks number 1 in the world in educational attainment. Despite the high rank of educational attainment, pockets of illiteracy still exist, particularly in impoverished areas. The US heavily promotes and provides access to higher learning avenues but falls short in making sure 100% of the country can utilize the higher learning avenues.

Reading ability and especially reading comprehension is an extremely important skill for success. Vocabulary skills are an important part of reading comprehension. Therefore, a challenging and fun way to build vocational skills especially in adults is needed.

In this disclosure an interactive vocabulary card game is described as well as a method for playing the interactive vocabulary card game. The card game not only provides training in vocabulary skills, but also is fun to play.

As used herein, the expression “vocabulary word” is used according to its commonly understood meaning and refers to a specific word of a specific language. The expression “word card” refers to a card with a specific vocabulary word located on it.

As used herein, the expression “definition” is used according to its commonly understood meaning and refers to an explanation of vocabulary word. The expression “definition card” refers to a card with a specific definition located on it.

The interactive vocabulary card game of this disclosure comprises a plurality of vocabulary cards and a receptacle for holding the plurality of vocabulary cards in a randomized pattern. The cards may be made from a variety of materials that are commonly used to make cards. In some embodiments, the cards are made from a plastic material or have a plastic coating. Being made of plastic or being coated with plastic has the advantage of high durability and are able to be sanitized by wiping or cleaning with disinfectants to prevent the spread of disease if the cards are used in a public setting.

The plurality of vocabulary cards are divided up into two collections of cards, with each card having a first major surface and a second major surface. The first collection of cards are “definition cards”. These definition cards comprise half of the total number of cards. Each definition card has on the first major surface a design element, the definition of a vocabulary word and a QR code that links to a vocabulary application with vocabulary words and definitions. The design element may be a separate element on the card surface, or it may serve as the background for the card surface. The second major surface of the definition card is either blank or contains a name, logo, or combination thereof for the game. The name may be a generic name such as “VOCABULARY CARD GAME” or it may be a trademarked or service marked name. Likewise, a logo if included may be a trademarked or service marked logo.

The second collection of cards are “word cards”. These word cards comprise half of the total number of cards. Each word card has on the first major surface a design element, a vocabulary word, the word's phonetic breakdown, a sentence using the vocabulary word, and a QR code that links to a vocabulary application with vocabulary words and definitions. As with the definition cards, the design element on the word cards may be a separate element on the card surface, or it may serve as the background for the card surface. The second major surface of the word card is either blank or contains a name, logo, or combination thereof for the game. The name be a generic name such as “VOCABULARY CARD GAME” or it may be a trademarked or service marked name. Likewise, a logo if included may be a trademarked or service marked logo. The name or logo on the second major surface is uniform for the definition cards and the word cards so a viewer of the cards does not know which type of card it is.

Each definition card in the set of playing cards has a matching word card. In this way, the plurality of playing cards is a plurality of matching sets of cards. The design elements on the first major surface of the definition and word cards match so that it is clear which definition card matches with which word card.

The playing cards typically are square in shape but may be in any desired shape such as rectangular, triangular or more complex shapes. The card can be of any desired size. In some embodiments, the cards are the size of conventional playing cards. In other embodiments, the cards may be larger or smaller as desired.

The QR codes on the cards link to a cell phone application that contains the words and definitions. Each individual QR code links to the specific word or definition on the card. The words and definitions can be selected to reflect the degree of challenge desired. For example, an introductory game may have relatively easy words and definitions, whereas an advanced game may have relatively difficult words and definitions. A combination of relatively easy words and definitions and difficult words and definitions may be included in the same game.

The design elements located on the first major side of the cards may take a wide variety of forms. In some embodiments, it may be desirable to have the design elements correspond to or be related to the word or definition of the card. In other embodiments, the design element may be unrelated to the word or definition of the card. In yet other embodiments, some design elements may correspond to the word or definition of the card and other design elements may not correspond to the word or definition of the card. A wide range of design elements are suitable such as geographic features, animals, plants, geometric shapes, numbers, objects, or people. Examples of geographic features include mountains, rivers, lakes, and the like. Examples of objects include objects that are representative of a city or region such as the Eiffel Tower or the Statue of Liberty. Examples of people include not only well-known individuals but also workers for specific jobs such as firefighters, miners, actors, teachers, and the like.

A wide range of examples of suitable combinations of word, definition, sentence, and design element could be provided, but a couple of examples are presented as representative. If the design element is the Statue of Liberty and the word is “freedom”, the phonetic breakdown could be [symbol] , the definition could be “the power or right to act, speak, or think as one wants” and the sentence could be “We do have some freedom of choice”. In this scenario, the first major surface of the two cards would have a picture of the Statue of Liberty. The word card would additionally include the word FREEDOM, the phonetic breakdown of the word [symbol] , the sentence WE DO HAVE SOME FREEDOM OF CHOICE and the QR code. The definition card would include, in addition to the picture of the Statue of Liberty, the phrase THE POWER OR RIGHT TO ACT, SPEAK, OR THINK AS ONE WANTS, and the QR code.

Another example is one in which the design element shows a picture of coal miners. In this scenario, the first major surface of the word card could contain the picture of coal miners, the word EXTRACTION, the phonetic breakdown [symbol] , the sentence THE MINERS REMOVED THE COAL FROM THE MINE BY EXTRACTION, and the QR code. The first major surface of the definition card could contain the picture of coal miners, the phrase THE ACTION OF TAKING OUT SOMETHING, ESPECIALLY USING EFFORT OR FORCE, and the QR code.

The plurality of vocabulary cards may be considered a deck of cards. The deck of cards may have any number of cards as long as it contains matched sets of word cards and definition cards. It may be possible to have a deck of cards with a relatively low number of cards such as 90 or less, or it may be desirable to have a deck of cards with a relatively high number of cards such as more than 300. In some embodiments, the deck of cards contains at least 90 cards. This number of cards permits large groups of players and also allows the game to be played for multiple rounds as will be explained below.

The interactive vocabulary card game also includes a receptacle to hold the cards in randomized order. A wide range of receptacles are suitable including a drawstring bag, a box, or a dish. In some embodiments, a drawstring bag is particularly suitable since this allows the cards to remain hidden when mixed and to remain hidden during the game.

The game may further comprise additional components including, for example, a scorecard or multiple scorecards, writing implements, sheets of instructions, and the like.

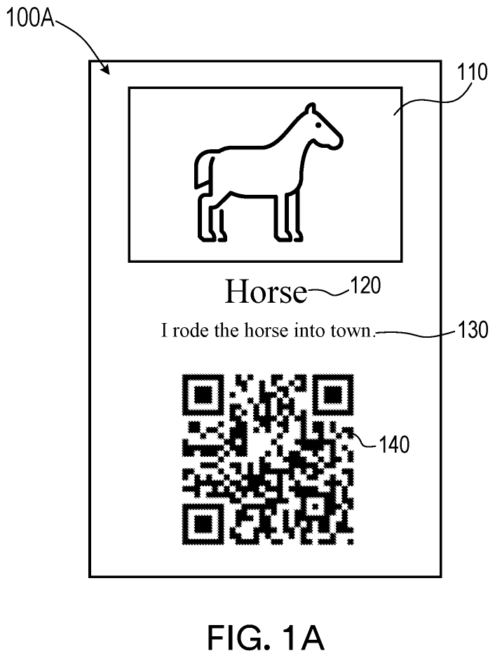

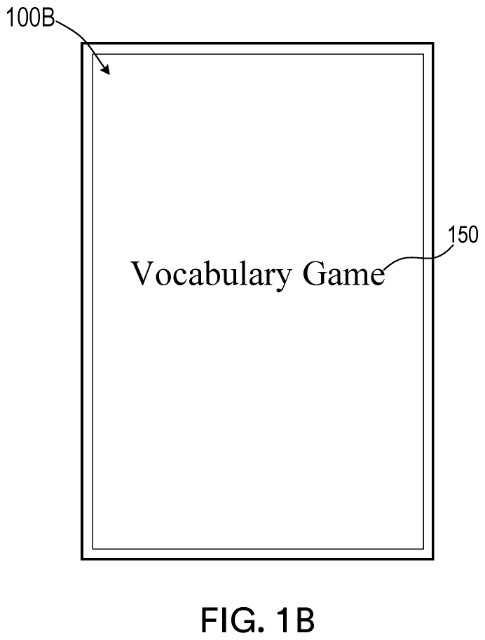

The game cards may be better understood through the figures. FIG. 1A depicts the first major surface 100A of a card of the second collection of cards (the word cards). The card contains design element 110, word 120, sentence 130, and QR code 140. In this example, the phonetic breakdown is not included. FIG. 1B depicts the second major surface 100B of the card shown in FIG. 1A. The card contains game name 150.

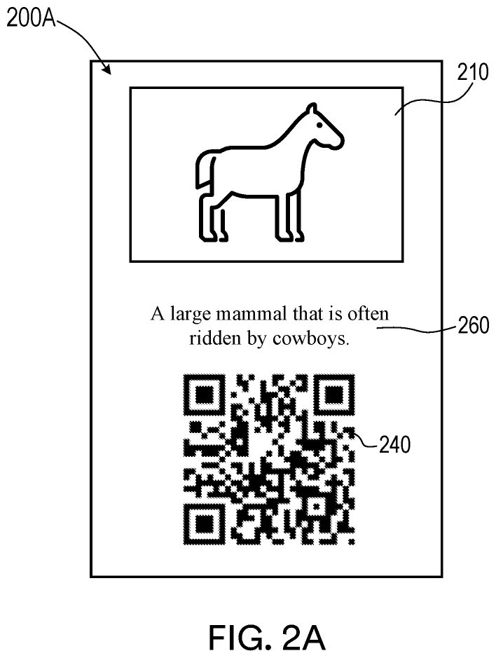

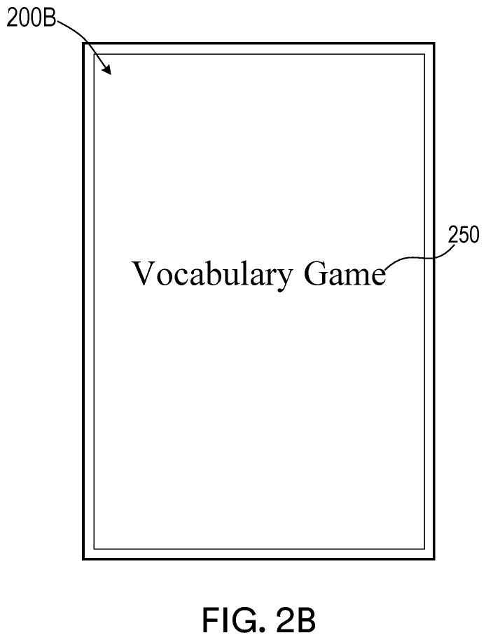

FIG. 2A depicts the first major surface 200A of a card of the first collection of cards (the definition cards). The card contains design element 210, definition 260, and QR code 240. FIG. 2B depicts the second major surface 200B of the card shown in FIG. 2A. The card contains game name 250.

Also disclosed herein are methods for playing an interactive vocabulary card game. The method for playing the game comprises providing a group of at least 3 players, and providing the vocabulary card game that is described above. The number of players is not particularly limited, but typically having at least 3 players makes playing the game more fun. Larger numbers of players are suitable, such as 4, 5, 6, 7, 8, 9, 10 or even more players. The game is played by rounds, where each round has each player having a turn. As will be described below, when it is his or her turn, the player can elect to skip his or her turn or become the asker. Once each player has had a turn, the round ends, and the next round begins. At any point in the game, the players can decide to end the game and upon completion of a last round the game ends.

The method may optionally include a playing surface, but a playing surface is not necessary. Examples of suitable playing surfaces include a table surface, a floor, or similar surface. If no flat surface is available, the game can be played without a playing surface with each player holding onto their cards throughout the game.

The vocabulary card game has been described above and comprises a plurality of cards and a receptacle. The game comprises a plurality of randomized vocabulary cards, each card having a first major surface and a second major surface. The plurality of randomized vocabulary cards comprises a first collection (definition cards) and second collection (word cards). The first collection of definition cards comprises half of the total cards and has on the first major surface a design element, the definition of a vocabulary word and a QR code that links to a vocabulary application with vocabulary words and definitions. The second major surface is either blank or contains a name, logo, or combination thereof for the game. The second collection of word cards comprise half of the total cards and each word card has on the first major surface a design element, a vocabulary word, the word's phonetic breakdown, a sentence using the vocabulary word, and a QR code that links to a vocabulary application with vocabulary words and definitions. The second major surface is either blank or contains a name, logo, or combination thereof for the game. The plurality of cards comprises matched sets of word and definition cards.

As mentioned above, the game is played by a group of at least 3 card players, Player 1, Player 2, and Player 3. Each card player draws 5 cards from the receptacle and hides the cards from the other players. Each player examines their 5 cards drawn to determine if any two of the cards form a matched set. By a matched set it is meant that the player has a word card and a definition card that match and have the same design element. If so, the player with the matched set places them on their scoring section of the playing surface, gains 5 points per match, and draws from the receptacle, such that each player begins the game with 5 cards.

The game begins with a first round. The first round starts with Player 1, the last player to draw cards from receptacle, taking his or her first turn, or Player 1 can choose to skip his or her turn. If Player 1 elects to play his or her turn, the first turn involves Player 1 asking a question (becoming the asker) about one of his or her cards to one or more of the other players (becoming the asked), and the possible responses by the asked player or players. The question comprises one of two options depending on what type of card the asker is asking about. If the card is a definition card, the question is whether the asked has a card with a word that means the definition written on the card. If the card is a vocabulary word card, the question is whether the asked has a card having the definition for the word written on the card.

The asked player or players can reply in one of two ways, each of these ways has a different outcome. The replies made by the asked player or players is known as an “offer”. In other words that asked player can offer that he or she has a match to asker player's card or the asked player can offer that he or she does not have a match to the asker player's card. Details of the outcomes of each possible response are given below.

The first option (option 1) is that the asked can reply by claiming to have a matching card and he or she says the word (if the asker has a definition card) from their card, or the definition (if the asker has a word card) from their card. The asker now has a variety of options. The asker can:
a) accept that the cards are a match, both players show their cards and if the design elements match, the asker places the matched set in their scoring section of the playing surface and gains 5 points, the asked gains 2 points, and the asker's turn ends; but if the cards do not match the asker must take the non-matching card, loses 2 points, and loses his or her turn, and the asked gains 2 points and draws 2 additional cards; or
b) the asker can question the asked, by having the asked read the sentence on the card if the claimed match card is of the second collection, for which the asked gains 1 point, or by having the asked act out silently the design element of the card if the claimed match card is of the first or second collection, for which the asked gains 3 points, after which the asker decides whether to accept or reject the asked player's card, such that:
   i) if the asker accepts and the card is a match, he or she places the matched set in their scoring section of the playing surface, gains 5 points, the asked gains 2 points along with the additional points gained from reading the sentence of the second collection (1 point) or silently acting out the design element of first or second card collections (3 points), and the asker's turn ends; or
   ii) if the asker accepts and the card is not a match, the asker must take the non-matching card, loses 2 points, and loses his or her turn, and the asked player gains 2 points and draws 2 additional cards along with any points from silently acting or reading the sentence; or
c) the asker can reject or “deny” that the offer (i.e. that there is a match) made by the asked are a match or, in the case of multiples offers (if the asker questions multiple asked players) may choose one of the offers to accept and the other offers are considered rejected and both the asker and asked reveal their cards to the group and
   i) if it is not a match, the asker gains 2 points and 2 cards, the asked loses 2 points and loses a turn;
   ii) if the card is a match, the asker forfeits their card to the asked and the asked gains 7 points; or
d) if the asker is very certain that the asked's card is or is not a match, after the asker states his or her decision on the offers given by the asked (that is to say whether or not the cards match), and before revealing cards from both parties to each other; the asker and an asked player can mutually bet on the correctness of the asker's decision. If the asker is correct for accepting or denying an asked offer he or she gains the original points outlined in a) or c) and gains an additional 4 points. If the asker stands corrected he or she does not gain additional points, while the asked who wagered, gains 4 points in addition to points gained if the asked read a sentence or silently acting out the design element. Players amongst the asked group who did not offer a match to the asker's card cannot place a bet.

The second option for the asked (option 2) is to claim to not have a match. The asker can:
e) accept that there is no match with the asked player or players, the asker draws a card from the receptacle and thus completes his or her turn. If the asker believes that an asked player has the match to their word or definition card, the asker forfeits their turn to challenge 1 card per asked player by showing the card in question, such that:
   i) if the asked has the matching card he or she must pass the card to the asker and the asker places the matched set in their scoring section of the playing surface, gains 5 points, and the asker's turn ends;
   ii) if the asked does not have the matching card, the asker must place the card in the center of the playing surface, and any later player having the matching card to the card in the center of the playing surface takes that card and places the matching set in their scoring section of the playing surface when it is their turn.

Upon completion of the first turn, the game moves on to a second turn, wherein Player 2, the player to the left of Player 1 becomes the asker, or Player 2 may skip his or her turn and draw 2 cards. If Player 2 does not skip his or her turn, the sequence of asking and responding given above is carried out.

Upon completion of the second turn, Player 3, the player to the left of Player 2 becomes the asker, or Player 3 may skip his or her turn and draw 2 cards. If Player 3 does not skip his or her turn, the sequence of asking and responding given above is carried out.

Play continues with each player taking turns until the game ends. The game can end in one of two ways. When all cards have found their match, the game ends. Alternatively, the group of players can decide to end the game, whereupon a final round is played where each player gets a turn. Upon completion of the game the players count up their points and the highest score wins.

Numerous variations of this game play can be carried out. The players can remove matched sets of cards from the starting deck of cards to shorten the game. For example, if the starting deck has 90 cards, the players can remove matching pairs of cards to reduce the number of cards to 80, 70, 60 or whatever number they deem reasonable.

As mentioned above, the game includes a receptacle for holding the cards in a randomized order. In some embodiments, the receptacle comprises a drawstring bag. If the players do not like using the drawstring bag, an alternative receptacle can be used such as a box or a dish.

Although specific embodiments of this invention have been shown and described herein, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. A method for playing an interactive vocabulary card game comprising:
providing a group of at least 3 card players, Player 1, Player 2, and Player 3;
providing a vocabulary card game, wherein the vocabulary card game comprises:
a plurality of randomized vocabulary cards, each card having a first major surface and a second major surface, wherein the plurality of randomized vocabulary cards comprises:
a first collection of definition cards comprising half of the total vocabulary cards, wherein each definition card has on the first major surface a design element, the definition of a vocabulary word and a QR code that links to a vocabulary application with vocabulary words and definitions, and the second major surface is either blank or contains a name, logo or combination thereof for the game; and
a second collection of word cards comprising half of the total vocabulary cards, wherein each word card has on the first major surface a design element, a vocabulary word, a sentence using the vocabulary word, and a QR code that links to a vocabulary application with vocabulary words and definitions, and the second major surface is either blank or contains a name, logo or combination thereof for the game;
wherein each definition card has a matching word card to form a matching set of cards, and the matching set of cards have the same design element; and
a receptacle for holding the plurality of vocabulary cards in a randomized pattern;
having each card player draw 5 cards from the receptacle, and hide the cards from the other players;
having each player examine their 5 cards drawn to determine if any two of the cards form a matched set, and if so the player with the matched set sets them aside, gains 5 points, and draws 2 additional cards from the receptacle, such that each player begins the game with 5 cards and maintains 5 cards in hand during play by drawing additional cards as necessary;
having a first round, wherein the first round comprises having Player 1 taking a first turn, Player 1 begins the game by asking a question (becoming the asker) about one of his or her cards to one or more of the other players (becoming the asked), wherein the question comprises:
if the card is a definition card, the question is whether the asked has a card with a word that means the definition written on the card; or
if the card is a vocabulary word card, the question is whether the asked has a card having the definition for the word written on the card;
having the asked player or players reply whether he or she has a matching card, called making an offer by the asked, wherein:
1) if the asked claims to have a matching card, he or she reads the word or definition from their card and the asker:
a) accepts that the cards are a match, both players show their cards and if the design elements match the asker sets aside the matched set and gains 5 points, the asked gains 2 points, and the asker's turn ends, but if the cards do not match the asker must take the non-matching card, loses 2 points, and loses his or her turn, and the asked gains 2 points and draws 2 additional cards; or
b) questions the asked, by having the asked read the sentence on the card if the claimed match card is of the second collection, for which the asked gains 1 point, or by having the asked act out silently the design element of the card if the claimed match card is of the second collection, for which the asked gains 3 points, after which the asker decides whether to accept or reject the asked player's card, such that:
i) if the asker accepts and the card is a match, he or she places the matched set aside, gains 5 points, the asked gains 2 points along with the additional points gained from reading the sentence of the second collection (1 point) or silently acting out the design element of their card (3 points), and the asker's turn ends;
ii) if the card is not a match, the asker must take the non-matching card, loses 2 points, and loses his or her turn, and the asked player gains 2 points and draws 2 additional cards along with any points from silently acting out the design element or reading the sentence;
c) rejects the offer made by the asked that the cards are a match or, in the case of multiples offers (if the asker questions multiple asked players) may choose one of the offers to accept and the other offers are considered rejected and both the asker and asked reveal their cards to the group and
i) if it is not a match, the asker gains 2 points and 1 card, the asked loses 2 points and loses their turn;
ii) if the card is a match, the asker forfeits their card to the asked and the asked gains 7 points; or
d) the asker, after stating his or her decision on whether or not his or her card matches with the asked's card and before the cards are revealed, can offer a wager with the asked player on the correctness of that decision, if the asked accepts the wager, the asker and asked reveal their cards such that:
i) if the asker was correct in his or her decision, he or she gains the original points outlined in a) or c) and gains an additional 4 points,
ii) if the asker is incorrect in his or her decision, he or does not gain additional points, while the asked who wagered, gains 4 points in addition to points gained if the asked read a sentence or silently acted out the design element;
wherein only the asker and asked may be involved in the wager;
2) if the asked claims to not have a match, the asker:
e) accepts that there is no match with the asked player or players, the asker draws a card from the receptacle and thus completes his or her turn; or
f) if the asker believes that asked player has a match, the asker can place his or her card where all the players can view the card and challenge the asked, such that:
i) if the asked has the matching card he or she must show it and the asker places the matched set aside, gains 5 points, and the asker's turn ends; or
ii) if the asked does not have the matching card, the asker must leave the card displayed where all players can view it and loses his or her turn, and any later player having the matching card to the card being displayed takes that card and places the matching set aside when it is their turn;
upon completion of the first turn, the round moves on to a second turn, wherein Player 2 becomes the asker, or Player 2 may skip his or her turn and draw 2 cards;
upon completion of the second turn, Player 3 becomes the asker, or Player 3 may skip his or her turn and draw 2 cards, thus completing the round;
play continues with each player taking turns until all cards are matched, or until the group of players decides to end the game, whereupon a final round is played where each player gets a turn, upon completion of the game the players count up their points and the highest score wins.

2. The method of claim 1, wherein the group of card players comprises more than 3 players.

3. The method of claim 1, wherein the plurality of vocabulary cards comprises at least 90 cards.

4. The method of claim 1, wherein the receptacle comprises a drawstring bag.

5. An interactive vocabulary card game comprising:
a plurality of vocabulary cards, wherein each of the plurality of vocabulary cards has a first major surface and a second major surface and comprises:
a first collection of definition cards comprising half of the total cards, wherein each definition card has on the first major surface a design element, the definition of a vocabulary word and a QR code that links to a vocabulary application with vocabulary words and definitions, and the second major surface of the card is either blank or contains a name, logo or combination thereof for the game; and
a second collection of word cards comprising half of the total cards, wherein each word card has on the first major surface a design element, a vocabulary word, a sentence using the vocabulary word, and a QR code that links to a vocabulary application with vocabulary words and definitions, and the second major surface of the card is either blank or contains a name, logo or combination thereof for the game;
such that each definition card has a matching word card to form a matching set of cards, and the matching set of cards have the same design element; and
a receptacle for holding the plurality of vocabulary cards in a randomized pattern.

6. The interactive vocabulary card game of claim 5, wherein the receptacle comprises a draw string bag or a box.

7. The interactive vocabulary card game of claim 5, wherein the design elements located on the first major side of the cards, comprise geographic features, animals, plants, geometric shapes, numbers, objects, or people.

8. The interactive vocabulary card game of claim 5, wherein the plurality of vocabulary cards comprises at least 90 cards.

9. The interactive vocabulary card game of claim 5, wherein the cards are made from plastic or have a plastic coating.

10. The interactive vocabulary card game of claim 5, further comprising a scorecard or a plurality of scorecards.
